(19) United States
(12) Patent Application Publication
(10) Pub. No.: US 2009/0054186 A1
(43) Pub. Date: Feb. 26, 2009

(54) Tensioner

(76) Inventors: Oliver Stegelmann, Strathroy (CA); Alben D'Silva, Windsor (CA)

Correspondence Address: THE GATES CORPORATION, IP LAW DEPT. 10-A3, 1551 WEWATTA STREET, DENVER, CO, 80202, US

(21) Appl. No.: 11/894,935

(22) Filed: Aug. 22, 2007

(51) Int. Cl. F16H 7/12

(52) U.S. Cl. 474/135

(57) ABSTRACT

A tensioner comprising a base, a pivot arm rotationally connected to the base, a pulley journalled to the pivot arm, a torsion spring engaged between the base and the pivot arm for biasing the pivot arm, a damping member non-rotatingly engaged with the base, a thrust plate rotationally moveable in conjunction with the pivot arm, and the torsion spring exerting an axial force directly upon the thrust plate and thereby upon the damping member, pressing the damping member into frictional engagement with the pivot arm and with the thrust plate.

### FIELD OF THE INVENTION

The invention relates to a tensioner, and more particularly, to a tensioner having a damping member non-rotatingly disposed between a thrust plate and a pivot arm.

### BACKGROUND OF THE INVENTION

The present invention is directed to a belt tensioner for a transmission belt system, and more specifically, to an improved damper assembly for the belt tensioner and a method for constructing the belt tensioner incorporating the improved damper assembly.

The main purpose of an automatic belt tensioner is to prolong the life of an engine or accessory drive belt. The most typical use for such automatic belt tensioners is on front-end accessory drives in an automobile engine. This drive includes pulley sheaves for each accessory the belt is required to power, such as the air conditioner, water pump, fan and alternator. Each of these accessories requires varying amounts of power at various times during operation. These power variations, or torsionals, create a slackening and tightening situation of each span of the belt. The belt tensioner is utilized to absorb these torsionals through use of an internally mounted torsion spring.

Representative of the art is U.S. Pat. No. 6,575,860 which discloses a belt tensioner for a power transmission belt system includes: (a) a base housing having a pivot shaft extending therefrom; (b) a tension arm pivotally mounted on the pivot shaft at a proximal end thereof, the proximal end of the tension arm including a rub surface and the distal end of the tension arm adapted to contact a power transmission belt; (c) a torsion spring operatively coupled between the base housing and the tension arm and adapted to bias the distal end of the tension arm against the power transmission belt; and (d) a damper assembly coupled to the housing, the damper assembly including: (1) a body of friction material that includes a friction surface adjacent to and facing the rub surface of the tension arm and (2) a damper spring integral with the body of friction material and biasing the body of friction material and associated friction surface against the rub surface of the tension arm.

What is needed is a tensioner having a damping member non-rotatingly disposed between a thrust plate and a pivot arm. The present invention meets this need.

### SUMMARY OF THE INVENTION

The primary aspect of the invention is to provide a damping member non-rotatingly disposed between a thrust plate and a pivot arm.

Other aspects of the invention will be pointed out or made obvious by the following description of the invention and the accompanying drawings.

The invention comprises a tensioner comprising a base, a pivot arm rotationally connected to the base, a pulley journalled to the pivot arm, a torsion spring engaged between the base and the pivot arm for biasing the pivot arm, a damping member non-rotatingly engaged with the base, a thrust plate rotationally moveable in conjunction with the pivot arm, and the torsion spring exerting an axial force directly upon the thrust plate and thereby upon the damping member, pressing the damping member into frictional engagement with the pivot arm and with the thrust plate.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the tensioner.

FIG. 2 is a perspective view of the tensioner.

FIG. 3 is an exploded view of the tensioner.

FIG. 4 is a lower perspective view of the tensioner.

### DETAILED DESCRIPTION OF THE PREFERRED EMBODIMENT

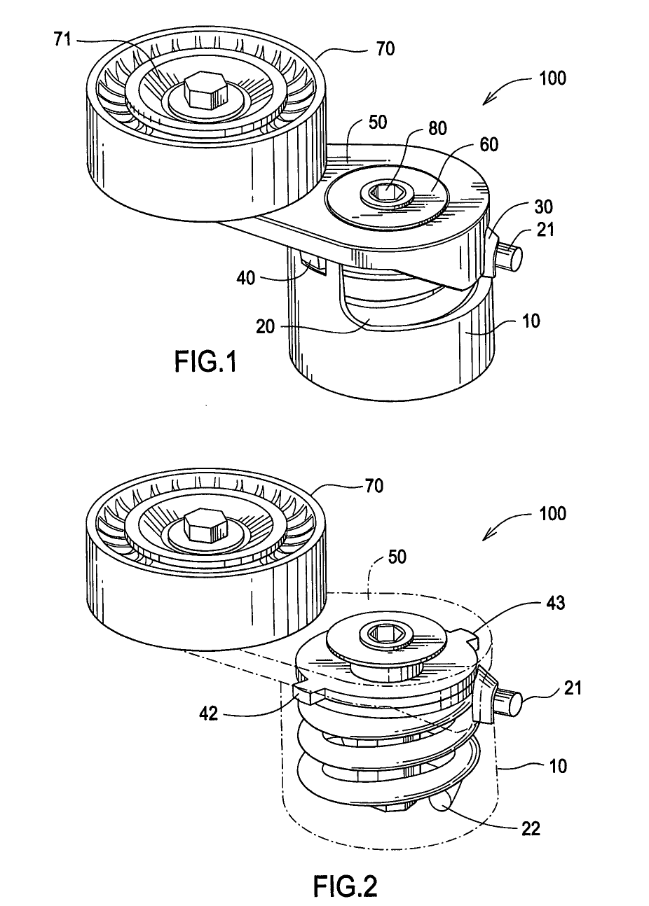

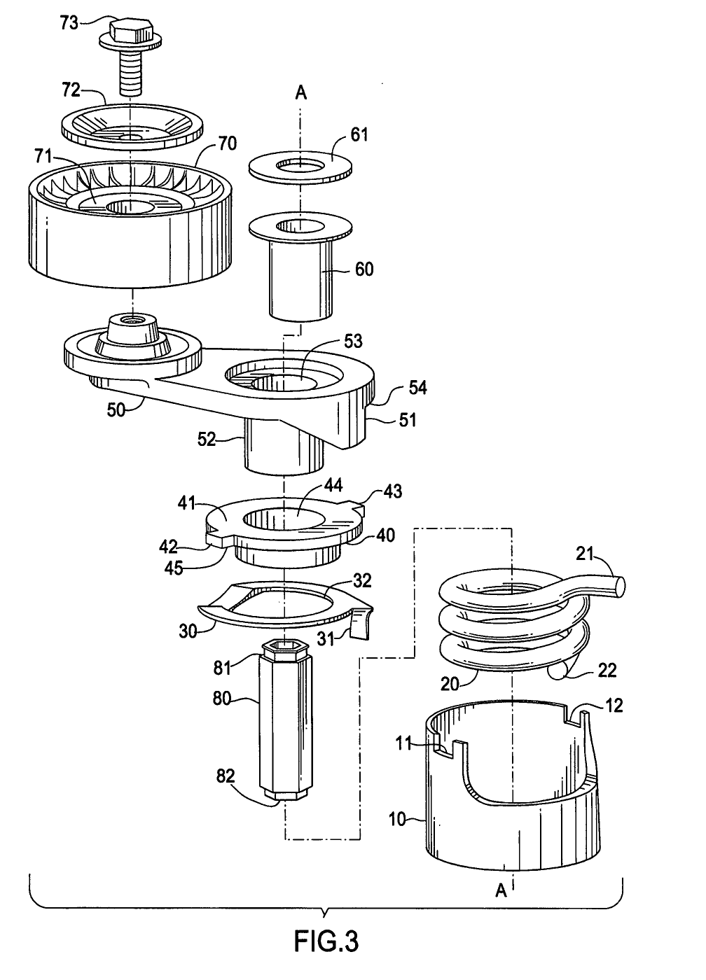

FIG. 1 is a perspective view of the tensioner. Tensioner 100 comprises a base 10 which can be fastened to a mounting surface such as an engine block (not shown). Pivot arm 50 is pivotally connected to base 10 by shaft 80, see FIG. 3. Low-friction bush 60 is disposed between shaft 80 and pivot arm 50. Bush 60 facilitates rotational movement of pivot arm 50 about shaft 80. Bush 60 comprises any suitable low friction material known in the art.

Torsion spring 20 is engaged between base 10 and pivot arm 50. End 22 engages base 10 and end 21 engages pivot arm 50, see FIG. 3. Torsion spring 20 exerts a spring force to bias pivot arm 50 and thereby apply a force to a belt (not shown) through pulley 70.

Pulley 70 is journalled to pivot arm 50 through bearing 71. Dust cover 72 keeps debris from entering bearing 71. Fastener 73 retains bearing 71 on pivot arm 50.

Thrust plate 30 comprises a substantially circular form. Thrust plate 30 is held in pressing engagement by torsion spring 20 against damping member 40. Thrust plate 30 is disposed between torsion spring 20 and damping member 40.

Damping member 40 is contained between thrust plate 30 and pivot arm 50. Damping member 40 comprises a surface 41 having a predetermined coefficient of friction. Surface 41 is in sliding engagement with pivot arm 50. Damping member 40 damps angular oscillations of pivot arm 50 during operation of the tensioner.

FIG. 2 is a perspective view of the tensioner. Damping member 40 is engaged with base 10 by tabs 42, 43. Tabs 42, 43 engage receiving portions 11, 12 respectively. Tabs 42, 43 prevent damping member 40 from rotating with respect to base 10. Damping member 40 is moveable in an axial direction with respect to shaft 80. The axial direction is shown in FIG. 3 along axis A-A.

FIG. 3 is an exploded view of the tensioner. Damping member 40 comprises tabs 42, 43. Tabs may extend in any direction from damping member 40. A single tab 42 may also be used to engage a receiving portion in base 10. Tabs 42, 43 engage receiving portions 11, 12 respectively. Surface 41 slidingly engages pivot arm 50. Surface 41 damps oscillatory movements of pivot arm 50. Damping member may comprise any suitable frictional material known in the movement damping arts.

End 21 of torsion spring 20 engages tab 31 of thrust plate 30. Tab 31 engages pivot arm member 51. Thrust plate 30 is holds damping member 40 in pressing engagement with pivot arm 50. Thrust plate 30 rotates in locked step with pivot arm 50 due to the engagement with member 51. A surface 32 is in sliding engagement with surface 45 of damping member 40. This engagement serves to damp oscillatory movements of pivot arm 50. Surface 54 on the underside of the pivot arm 50 is also in frictional sliding engagement with surface 41. In operation the pivot arm 50 and thrust plate 30 rotate in unison while damping member 40 does not rotate.

Bush 60 is engaged about the outer perimeter of shaft 80. The outer portion of bush 60 slidingly engages the inner surface 53 of pivot arm 50. Press fit washer 61 engages an end 81 of shaft 80 to hold the tensioner together. Washer 61 may also comprise a snap ring. A fastener such as a bolt (not shown) is inserted into bore 82 for fastening the tensioner to a mounting surface.

Damping member bore surface 44 engages pivot arm shaft 52. Surface 44 comprises a predetermined coefficient of friction for sliding engagement with shaft 53. This assists in damping oscillatory movements of pivot arm 50.

End 21 of spring 20 bears upon tab 31 which in turn bears upon member 51. A spring force for biasing the pivot arm is transmitted from end 21 to pivot arm 50 through tab 31 and member 51.

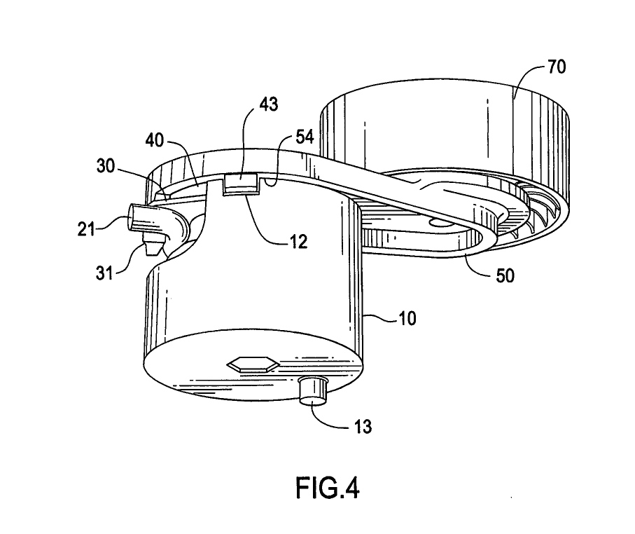

FIG. 4 is a lower perspective view of the tensioner. Projection 13 prevents rotational movement of base 10 during operation and orients the tensioner during installation. Tab 43 engages receiving portion 12 of base 10 to prevent rotational movement of damping member 40. Thrust plate 30 and pivot arm 50 rotate in unison. Thrust plate 30 and pivot arm 50 slidingly engage opposite sides of damping member 40 thereby capturing the damping member between the two moving components. Frictional engagement of the thrust plate 30 and the pivot arm 50 with opposite sides of damping member 30 serves to damp oscillatory movements of the pivot arm 50 during operation. The constant axial force from torsion spring 20 and the axial freedom on movement of the damping member 30 allows the tensioner to self adjust as the damping member wears from use. Since the damping member 30 is captured between the thrust plate and the pivot arm, there is no range of operation where there is zero damping.

In an alternate embodiment if it is desired that some undamped motion is required, this feature can be easily accomplished by enlarging the size of the receiving portions 11, 12 to allow some predetermined amount of rotational movement of the damping member 30 with respect to base 10.

Although forms of the invention has been described herein, it will be obvious to those skilled in the art that variations may be made in the construction and relation of parts and method without departing from the spirit and scope of the invention described herein.

We claim:

1. A tensioner comprising:
a base;
a pivot arm rotationally connected to the base;
a pulley journalled to the pivot arm;
a torsion spring engaged between the base and the pivot arm for biasing the pivot arm;
a damping member non-rotatingly engaged with the base;
a thrust plate rotationally moveable in conjunction with the pivot arm; and
the torsion spring exerting an axial force directly upon the thrust plate and thereby upon the damping member, pressing the damping member into frictional engagement with the pivot arm and with the thrust plate.

2. The tensioner as in claim 1, wherein the thrust plate is engaged with the pivot arm so as to move in unison with the pivot arm.

3. The tensioner as in claim 1, wherein the damping member is axially moveable with respect to the torsion spring.

4. The tensioner as in claim 1, wherein the damping member further comprises a means for engaging the base for preventing rotational movement of the damping member with respect to the base while allowing axial movement of the damping member with respect to the base.
